(19) United States
(12) Patent Application Publication
(10) Pub. No.: US 2003/0070579 A1
(43) Pub. Date: Apr. 17, 2003

(54) Preformed thermoplastic pavement marking construction

(76) Inventors: Le Hoa Hong, Monterey Park, CA (US); Jesse C. Ercillo, Covina, CA (US); Chan U. Ko, Arcadia, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/969,494

(22) Filed: Oct. 1, 2001

(51) Int. Cl. C09D 1/00; C09K 3/00; C09D 4/00; C09D 5/00; C09D 11/00; B32B 7/12; B32B 15/04

(52) U.S. Cl. 106/31.04; 428/343

(57) ABSTRACT

A cold stick pavement marking construction is provided which includes a top flexible layer and a lower adhesive layer for adhering the pavement marking construction to a pavement surface. The top layer includes thermoplastic elastomer, resin, wax and filler. The wax and resin are preferably at least partially miscible with the thermoplastic elastomer in order to prevent phase separation of the top layer. Optionally, the top layer of the pavement marking construction includes retroreflective elements for improved visibility, and skid-resistant particles for improved traction for both vehicles and pedestrians. Other ingredients in the top layer include liquid rubber, plasticizer and antioxidant.

### FIELD OF THE INVENTION

The present invention is directed to a material to be used for marking paved surfaces such as those commonly used for roadways and parking areas. More particularly, it is directed to a self-adhesive, preformed thermoplastic pavement marking construction.

### BACKGROUND OF THE INVENTION

Pavement marking constructions are used extensively to visually delineate various information on paved areas such as roadways and parking areas. Roadways are commonly marked with lines to identify the edges or center of a road, or to distinguish the various lanes of a roadway. Similarly, roadways are often marked with lines to identify crosswalks at intersections or parking spaces on the side of a road. Sometimes roadways can include textual messages with traffic instructions such as the word “STOP.” Roadways can also include symbols such as arrows are useful for emphasizing traffic patterns, or a symbol with a graphical representation of a bicycle for identifying bicycle lanes.

The paved portions of parking structures such as parking lots similarly use various markings to provide useful information to motorists such as roadway markings, crosswalks, parking spaces and textual messages with simple traffic instructions. In addition to textual and graphical traffic instructions such as the word “STOP” or arrows similar to those used on roadways, parking structures often include other simple textual information such as “ENTER,” “EXIT,” or “DRIVE-THRU.” It is also common for parking structures to use symbols to identify those parking places reserved for handicapped persons. Moreover, some establishments choose to decorate the pavement of a parking lot with graphical information such as a corporate logo.

Traditionally, pavement markings are either applied to a pavement surface as a liquid such as a paint, or as a preformed sheet or strip. Liquids such as paints can be provided in many forms including solvent-based paints or two-part epoxy paints. The application of pavement markings using paint generally requires special skill on the part of the painter and sometimes expensive painting equipment. The often lengthy drying times associated with liquid pavement markings can also result in increased manpower costs and can be an inconvenience to motorists due to road closures to accommodate pavement marking operations. Furthermore, it is often desired for the pavement marking to be skid-resistant or reflective and for such applications skid-resistant particles and retroreflective elements must either be mixed into the paint, or applied to the surface of the wet paint after the paint has been applied. Either method requires additional steps, lengthening the application time. Furthermore, where mixing of a solvent-based or epoxy paint or liquid is required, still further skills are required of the worker or workers who mix such a paint or liquid as the quality of the finished product depends heavily on whether or not the ingredients have been mixed in the proper proportions.

More recently, preformed strips or sheets of pavement marking constructions have been used for pavement marking. One benefit of such preformed materials is that retroreflective elements and skid-resistant particles can be added to the preformed sheets or strips during manufacture, simplifying their application. Another benefit is that, unlike a liquid-based marking materials, little if any drying or curing time is required once they are applied. This permits traffic flow to be resumed more quickly than for marking materials requiring drying or curing time.

Preformed sheets and strips of pavement marking are generally one of two types. The first is a type in which the preformed strip or sheet is first placed in the desired location on the pavement and then is heated in order to melt and adhere it to the pavement surface. The second type generally uses a pressure sensitive adhesive to affix the pavement marking construction to the pavement. For ease of reference in this specification, the first type of preformed pavement marking construction will be referred to as a “hot stick” construction and the second type will be referred to as a “cold stick” construction.

For a hot stick type of pavement marking construction, one common way of heating such a strip or sheet is by using a propane torch. While hot stick constructions offer certain benefits over liquid-based marking materials, the application of a hot-stick pavement marking strip or sheet with a torch can be quite time consuming in that the entire surface of the sheet or strip must be heated to ensure a good bond to the pavement surface. Furthermore, its application also requires some degree of skill on the part of the person applying it in order to assure that the entire strip or sheet is adequately bonded to the pavement surface without applying so much heat that the surface of the preformed strip or sheet is burned or scorched. Moreover, the use of compressed cylinders of flammable gas such as propane is generally inconvenient due to both the special equipment required to safely contain and use such gases as well as the special safety precautions required in handling containers of compressed flammable gases.

The cold stick types of pavement marking constructions are generally quite simple to install. Typically, the adhesive is already on the underside of the pavement marking construction, protected by a release liner. To apply, the release liner is peeled from the adhesive and the construction is pressed directly to a clean pavement surface. If necessary, it is rolled down after application to ensure a good bond to the pavement. In practice, another common technique for rolling down a cold stick pavement marking construction is by driving a car or truck over the construction. However, while cold stick pavement marking materials are generally quite simple to apply, they have not generally proven to be as durable as is desirable.

Durability problems common to most prior art pavement marking strips and sheets are that such strips and sheets often separate from the pavement surface when exposed to the rigors of vehicle traffic. The forces that cause such separation include the impact forces imparted by a vehicle's tires as each tire strikes the edge of the marking material. Shear forces are also imparted by a tire as it passes along the top surface of the marking material, especially if the vehicle is braking or accelerating, and especially if the traffic patterns are perpendicular to any seams or edges of the pavement marking strip or sheet. Another important drawback to a preformed pavement marking construction is that when compared to markings applied in a liquid form, such preformed constructions do not generally conform as easily to complicated surfaces such as those which might be encountered on a rough road or at cracks or joints such as those commonly found on pavement surfaces.

In addition to being required to withstand the forces imparted by vehicular traffic, pavement marking constructions of all types are typically exposed to elements of nature including rain and snow, as well as extremes in temperature. Still further, pavement marking materials are subjected to the oil and dirt common to pavement surfaces. These environmental conditions together tend to cause premature wear of the upper portion of a pavement marking material and premature failure of the pavement marking material's bond to the pavement surface.

Still further durability problems may arise in that the pavement surfaces to which a pavement marking is to be applied can be of different materials. Roadways are typically made of asphalt or poured concrete, but for some applications can also be made of concrete blocks or pavers or clay bricks. Some pavement marking constructions, while adhering well to an asphalt surface, may prematurely peel if applied to a concrete or clay surface.

### SUMMARY OF THE INVENTION

A cold stick pavement marking construction is provided which includes a top flexible marking layer and a lower adhesive layer for adhering the pavement marking construction to a pavement surface. The top layer includes thermoplastic elastomer, resin, wax and filler. Optionally, the top layer also includes retroreflective elements to provide improved visibility, and skid-resistant particles to provide improved traction for both vehicles and pedestrians. The top layer can also include liquid rubber, plasticizer and antioxidant, each of which contributes to the strength and durability of the pavement marking construction.

Preferably, the top layer includes between about 4% and 14% by weight thermoplastic elastomer, between about 7% and 15% by weight resin, between about 1% and 4% by weight wax, and between about 40% and 95% by weight filler. Preferred thermoplastic elastomers include natural rubber, polyisoprene, polybutadiene, polyisobutylene, butyl rubber, ethylene-propylene rubber, ethylene-propylene-diene monomer rubber, polyethylene, polybutylene, poly (alpha-olefin), styrene-butadiene random copolymers, plastomers and styrenic block copolymers, with styrenic block copolymers having at least about 30% by weight styrene being most preferred.

Preferred resins include hydrocarbon resins, polyester resins, maleic resins, phenoloic resins, epoxy resins, acrylic resins, rosins, rosin derivatives, terpenes, terpene and phenolic derivatives. Preferred waxes include polyethylene waxes, polypropylene waxes, polyamide waxes, stearates, and hydrocarbon-based waxes. It is important that the waxes and resins used be at least partially miscible with the thermoplastic elastomer so that complete phase separation within the top layer does not occur. In such cases where the waxes and resins fully phase separate from the elastomers and rubbers, shear impact resistance and aesthetic appearance of the top layer decrease.

The pavement marking construction of the present invention is preferably provided with a release liner protecting the exposed adhesive surface. Application of the pavement marking construction merely requires the cleaning of the pavement surface, the removal of the release liner from the construction, application of the construction to the pavement surface and rolling down of the applied pavement marking construction to ensure a good bond with the pavement surface. In some embodiments, a suitable primer may be applied to the road surface to improve the adhesion of the pavement marking construction to the road. In addition to permitting fast and simple installation, the pavement marking construction offers improved strength and durability over existing pavement marking constructions.

### BRIEF DESCRIPTION OF THE DRAWINGS

FIG. 1 is a cross-sectional side view of a first embodiment of a pavement marking construction of the present invention; and

FIG. 2 is a cross-sectional side view of a second embodiment of a pavement marking construction of the present invention.

### DETAILED DESCRIPTION OF THE INVENTION

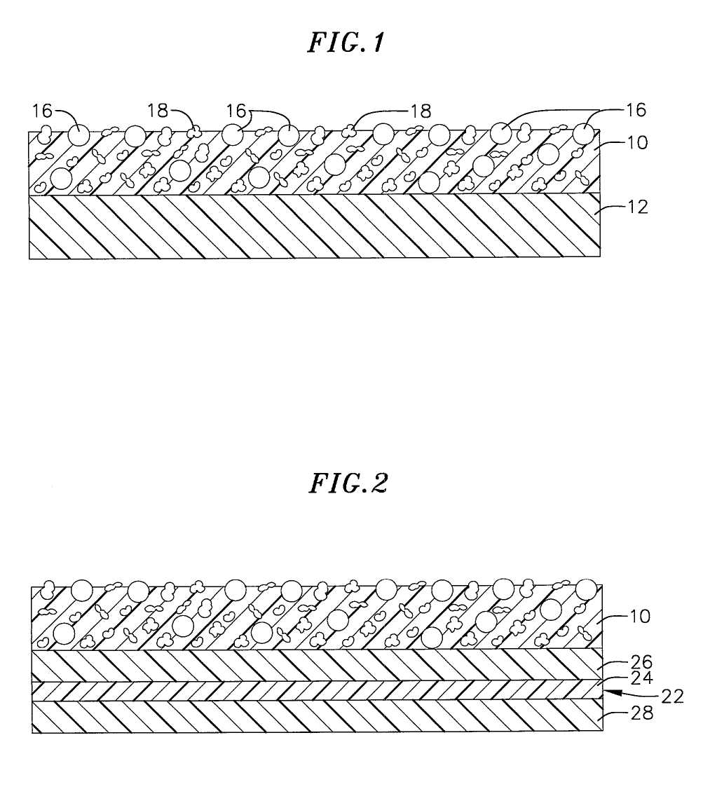

As illustrated by FIG. 1, a pavement marking construction of the present invention is provided as a sheet or strip that includes a top layer 10 and an adhesive layer 12. In the preferred embodiment, the adhesive layer of the construction is protected until ready for application to the pavement surface by a release liner as is well known in the art.

The top layer preferably includes retroreflective elements 16 and skid-resistant particles 18 embedded within its surface. In the preferred embodiment, such particles are provided throughout the top layer rather than just on its outermost surface so that the retroreflective and skid-resistant properties are maintained even if the top layer wears down.

The top layer is generally made of a combination of a thermoplastic elastomer, a resin system, a wax, and filler. Other desirable ingredients can include plasticizers, liquid rubbers, antioxidants, pigments, retroreflective elements, and skid-resistant particles.

The thermoplastic elastomers useful in the invention are preferably those having glass transition temperature between about −120° C. and −30° C., tensile strength from about 300 psi (21 bar) to 5,000 psi (345 bar) according to ASTM test method D 412, and elongation at break between about 500 and 1700%, also using ASTM test method D 412. The thermoplastic elastomers are preferably present in the top layer of the pavement marking construction at between about 4 and 14 weight %. These elastomers may be used singly or in combination.

Suitable thermoplastic elastomers include natural rubber, polyisoprene, polybutadiene, polyisobutylene, butyl rubber, ethylene-propylene rubber, ethylene-propylene-diene monomer rubber (EPDM), polyethylene, polybutylene, poly (alpha-olefin), styrene-butadiene random copolymers, polyamide, plastomers, and styrenic block copolymers (SBCs).

Preferred thermoplastic rubber based elastomers include linear, branched, graft or radial block copolymers represented by the diblock structures A-B, the triblock structures A-B-A, the radial or coupled structures (A-B)n, and combinations of these where A represents a hard thermoplastic phase or block which is non-rubbery or glassy or crystalline at room temperature but fluid at higher temperatures, and B represents a soft block which is rubbery or elastomeric at service or room temperature. These thermoplastic elastomers may comprise from about 69% to about 95% by weight of rubbery segments and from about 5% to about 31% by weight of non-rubbery segments.

The non-rubbery segments or hard blocks comprise polymers of mono- and poly-cyclic aromatic hydrocarbons, and more particularly vinyl substituted aromatic hydrocarbons which may be monocyclic or bicyclic in nature. The preferred rubbery blocks or segments are polymer blocks of homopolymers or copolymers of aliphatic conjugated dienes. Rubbery materials such as polyisoprene, polybutadiene, and styrene butadiene rubbers may be used to form the rubbery block or segment. Particularly preferred rubbery segments include polydienes and saturated olefin rubbers of ethylene/butylene or ethylene/propylene copolymers. The latter rubbers may be obtained from the corresponding unsaturated polyalkylene moieties such as polybutadiene and polyisoprene by hydrogenation thereof.

The block copolymers of vinyl aromatic hydrocarbons and conjugated dienes which may be utilized include any of those which exhibit elastomeric properties. The block copolymers may be diblock, triblock, multiblock, starblock, polyblock or graftblock copolymers. Such block copolymers may contain various ratios of conjugated dienes to vinyl aromatic hydrocarbons including those containing up to about 40% by weight of vinyl aromatic hydrocarbon. Accordingly, multi-block copolymers may be utilized which are linear or radial, symmetric or asymmetric, and which have structures represented by the formulae A-B, A-B-A, A-B-A-B, B-A-B, (AB)_{O,1 2} . . . BA, etc., wherein A is a polymer block of a vinyl aromatic hydrocarbon or a conjugated diene/vinyl aromatic hydrocarbon tapered copolymer block, and B is a rubbery polymer block of a conjugated diene.

The block copolymers may be prepared by any of the well-known block polymerization or copolymerization procedures including sequential addition of monomer, incremental addition of monomer, or coupling techniques as illustrated in, for example, U.S. Pat. Nos. 3,251,905; 3,390,207; 3,598,887; and 4,219,627. As is well known, tapered copolymer blocks can be incorporated in the multi-block copolymers by copolymerizing a mixture of conjugated diene and vinyl aromatic hydrocarbon monomers utilizing the difference in their copolymerization reactivity rates. Various patents describe the preparation of multi-block copolymers containing tapered copolymer blocks including U.S. Pat. Nos. 3,251,905; 3,639,521; and 4,208,356, the disclosures of which are hereby incorporated by reference.

Conjugated dienes which may be utilized to prepare the polymers and copolymers are those containing from 4 to about 10 carbon atoms and more generally, from 4 to 6 carbon atoms. Examples include from 1,3-butadiene, 2-methyl-1,3-butadiene (isoprene), 2,3-dimethyl-1,3-butadiene, chloroprene, 1,3-pentadiene, 1,3-hexadiene, etc. Mixtures of these conjugated dienes also may be used. The preferred conjugated dienes are isoprene and 1,3-butadiene.

Examples of vinyl aromatic hydrocarbons which may be utilized to prepare the copolymers include styrene and the various substituted styrenes such as o-methylstyrene, p-methylstyrene, p-tert-butyl styrene, 1,3-dimethylstyrene, alpha-methylstyrene, beta-methylstyrene, p-isopropylstyrene, 2,3-dimethylstyrene, o-chlorostyrene, p-chlorostyrene, o-bromostyrene, 2-chloro-4-methylstyrene, etc. The preferred vinyl aromatic hydrocarbon is styrene.

Many of the above-described copolymers of conjugated dienes and vinyl aromatic compounds are commercially available. The number average molecular weight of the block copolymers, prior to hydrogenation, is from about 20,000 to about 500,000, preferably from about 40,000 to about 300,000.

The average molecular weights of the individual blocks within the copolymers may vary within certain limits. In most instances, the vinyl aromatic block will have a number average molecular weight in the order of about 2000 to about 125,000, and preferably between about 4000 and 60,000. The conjugated diene blocks either before or after hydrogenation will have number average molecular weights in the order of about 10,000 to about 450,000 and more preferably from about 35,000 to 150,000.

Also, prior to hydrogenation, the vinyl content of the conjugated diene portion generally is from about 10% to about 80%, and the vinyl content is preferably from about 25% to about 65%, particularly 35% to 55% when it is desired that the modified block copolymer exhibit rubbery elasticity.

In one embodiment, the conjugated diene portion of the block copolymer is at least 90% saturated and more often at least 95% saturated while the vinyl aromatic portion is not significantly hydrogenated. Particularly useful hydrogenated block copolymers are hydrogenated products of the block copolymers of styrene-isoprene-styrene such as a styrene-(ethylene/propylene)-styrene block polymer. When a polystyrene-polybutadiene-polystyrene block copolymer is hydrogenated, it is desirable that the 1,2-polybutadiene to 1,4-polybutadiene ratio in the polymer is from about 30:70 to about 70:30. When such a block copolymer is hydrogenated, the resulting product resembles a regular copolymer block of ethylene and 1-butene (EB). As noted above, when the conjugated diene employed is isoprene, the resulting hydrogenated product resembles a regular copolymer block of ethylene and propylene (EP).

A number of selectively hydrogenated block copolymers are available commercially from Shell Chemical Company under the general trade designation KRATON G. One example is KRATON G 1652 which is a hydrogenated SBS triblock comprising about 30% by weight of styrene end blocks and a midblock which is a copolymer of ethylene and 1-butene (EB). A lower molecular weight version of G 1652 is available from Shell under the designation KRATON G 1650. KRATON 1651 is another SEBS block copolymer which contains about 33% by weight of styrene. KRATON G 1657 is an SEBS diblock copolymer which contains about 13% w styrene. This styrene content is lower than the styrene content in KRATON G 1650 and KRATON G 1652.

The block copolymers may also include functionalized polymers such as may be obtained by reacting an alpha, beta-olefinically unsaturated monocarboxylic or dicarboxylic acid reagent onto selectively hydrogenated block copolymers of vinyl aromatic hydrocarbons and conjugated dienes.

The preparation of various selectively hydrogenated block copolymers of conjugated dienes and vinyl aromatic hydrocarbons which have been grafted with a carboxylic acid reagent is described in a number of patents including U.S. Pat. Nos. 4,578,429; 4,657,970; and 4,795,782, and the disclosures of these patents relating to grafted selectively hydrogenated block copolymers of conjugated dienes and vinyl aromatic compounds, and the preparation of such compounds are hereby incorporated by reference. U.S. Pat. No. 4,795,782 describes and gives examples of the preparation of the grafted block copolymers by the solution process and the melt process. U.S. Pat. No. 4,578,429 contains an example of grafting of KRATON G 1652 (SEBS) polymer with maleic anhydride with 2,5-dimethyl-2,5-di(t-butylperoxy) hexane by a melt reaction in a twin screw extruder. (See Col. 8, lines 40-61.) Examples of commercially available maleated selectively hydrogenated copolymers of styrene and butadiene include KRATON FG 1901 X, FG 1921 X, and FG 1 924X from Shell, often referred to as maleated selectively hydrogenated SEBS copolymers. FG1901 X contains about 1.7% by weight bound functionality as succinic anhydride and about 28% by weight of styrene. FG1921X contains about 1%w of bound functionality as succinic anhydride and 29% by weight of styrene. FG1924X contains about 13% styrene and about 1% bound functionality as succinic anhydride.

The styrenic block copolymers (SBCs) most useful in the invention have radial or linear (that is, diblock or triblock) molecular structures, with the elastomeric blocks typically being butadiene, isoprene, and ethylene/butylene. For SBCs it is also preferred that such copolymers include at least 30% by weight styrene. On the one hand, at room temperature, the thermoplastic polystyrene blocks of the SBCs are hard and mechanically strong, thus imparting good impact resistance to the top layer of the pavement marking construction. On the other hand, the elastomeric blocks of the SBCs are soft and flexible, imparting increased flexibility and shock absorbent properties to the top layer. A preferred SBC is a styrene-butadiene-styrene (SBS) block copolymer sold under the name KRATON D1101 by Shell.

Plastomers are generally polymers exhibiting both plastic and elastomeric properties. Preferred plastomers are copolymers of ethylene and alkene in which the alkene groups have between about 4 and 8 carbon atoms. Such plastomers generally have a softening point between about 50° C. and 100° C. Such plastomers offer unique properties in that they generally have higher tensile strength than a styrenic block copolymer. Preferred plastomers include the polymers sold under the EXACT name by Exxon Mobil, with the most preferred being EXACT 8201 and 9108.

Other preferred thermoplastic elastomers include ethylene-acrylate and ethylene-acetate, and reactive ethylene/glycidyl/acrylate terpolymers. The ethylene terpolymer consists of an ethylene backbone modified by functional groups such as acrylate, acetate, carbon monoxide, and glycidyl. Since the ethylene backbone is saturated, it is relatively oxidation- or aging-resistant compared to unsaturated thermoplastic elastomers. For these terpolymers which contain the acrylate side group, this functionality adds flexibility and elastomeric properties to the top layer, thereby, decreasing the amount of liquid plasticizers or resins required for conformability to rough road surfaces. Such thermoplastic elastomers are useful in that they also act as solid plasticizers. Preferred ethylene-acrylate thermoplastic elastomers include, for example, ELVALOY HP terpolymers made by DuPont. Solid plasticizers offer certain benefits over liquid plasticizers in that liquid plasticizers can have a tendency to migrate to the surface of the top layer of the pavement marking construction, making them susceptible to evaporation, especially upon exposure to heat or sunlight. If the plasticizers evaporate or are otherwise extracted from the construction, the construction would tend to become undesirably brittle. Consequently, the inclusion of such thermoplastic elastomers results in a construction that offers both toughness and long-term flexibility.

Useful solid and liquid resins for the top layer of the pavement marking constructions of the present invention include hydrocarbon resins, polyester resins, maleic resins, phenolic resins, epoxy resins, acrylic resins, rosin and rosin derivatives, terpene and terpene phenolic derivatives. These resins may be used singly or in combination. The preferred softening point range for liquid and solid resins are 1° C. to 25° C. and 60° C. to 140° C., respectively. These resins are substantially miscible with the thermoplastic elastomers and liquid rubber at not only the molten processing conditions, but also upon cooling from the molten state to the intended operating temperature range of between about −30° F. and 140° F. The miscibility prevents the resin from separating out of the elastomers or rubbers, leading to degradation in the mechanical properties (i.e. tensile strength, durability, high temperature shear resistance, etc.) and aesthetic properties of the top layer. Preferably, the total resin content, both solid and liquid, is between 7 and 15% by weight.

Conventional solid tackifier resins that are useful in the invention include hydrocarbon resins, rosin, hydrogenated rosin, rosin esters, polyterpene resins, and other resins which exhibit the proper balance of properties. A variety of useful solid tackifier resins are available commercially such as terpene resins which are sold under the trademark ZONATAC by Arizona Chemical Company, and petroleum hydrocarbons resins such as the resins sold under the trademark ESCOREZ by Exxon Chemical Company. One particular example of a solid tackifier is ESCOREZ 2596 which is a C₅-C₉ (aromatic modified aliphatic) synthetic tackifier having an Mw of 2100 and a dispersity (Mw/Mn) of 2.69. Another example of a solid tackifier is ESCOREZ 131 OLC, identified as an aliphatic hydrocarbon resin having an Mw of 1350 and a dispersity of 1.8. WINGTACK 95 is a synthetic tackifier resin available from Goodyear, Akron, Ohio consisting predominantly of polymerized structure derived from piperylene and isoprene.

Preferred rosin and rosin derivatives include alkyd (maleic modified glycerol ester of rosin), pentaerythritol or glycerol ester of rosin, and liquid hydrogenated methyl ester. Preferred hydrocarbon resins include petroleum based resins with between five and nine carbons. The preferred terpenes are terpenes based on alpha- or beta-pinene, dipentene, or limonene. Preferred terpene phenolics are copolymers of terpene base monomers with phenol monomers. Particularly preferred resin binders include an alkyd ester of rosin sold by Arizona Chemicals under the name UNIREZ 7021, a hydrocarbon resin sold by Eastman Chemical under the name EASTOTAC Resin H100E, and rosins sold by Hercules under the name HERCOLYN D-E and by Eastman Chemical under the name FORALYN 5020-F.

In one embodiment, it is preferred to include a resin binder system comprising a combination of both liquid and solid resins. The solid resin binds the other ingredients such as the wax, filler, retroreflective elements, and skid-resistant particles together to form a coatable thermoplastic layer. The solid resin can also impart improved durability to the construction. Alkyd resins are particularly preferred solid resins.

The inclusion of a liquid resin imparts flexibility to the top layer and improves the flow characteristics during production of the construction, especially if low pressure extrusion equipment is used. In effect, the liquid resin functions as a polymer modifier or processing aid, improving top layer conformability. However, where high pressure extrusion equipment is to be used in producing pavement marking constructions according to the present invention, the use of solid resin binders is preferred as the benefits imparted by liquid resin binders are less important.

The waxes useful in the invention generally include polyethylene and polypropylene waxes, either homopolymers or grafted with different functionalities such as maleic anhydride, polyamide waxes, stearates, and hydrocarbon-based waxes. Such waxes may be used singly or in combination. Inclusion of a wax imparts both smudge resistant properties to the finished product and aids in the processing of the materials. However, excessive use of wax can detrimentally affect the adhesion of the retroreflective elements and skid-resistant particles within the top layer resulting in a less reflective and slippery construction, and can adversely affect the adhesion of the top layer to the pressure sensitive adhesive. Like the resin, it is preferred that the wax is substantially miscible with the other polymers in the top layer of the pavement marking construction of the present invention, and will not fully phase separate upon cooling from a molten state, and most preferably, will not fully phase separate at the intended operating temperatures in the range of between about −30° F. and 140° F. The preferred waxes include those with a softening point between about 30° C. and 140° C. using ASTM ring and ball test method E28, a penetration hardness of less than 0.1 to 5.0 millimeters using ASTM 1321 needle penetration test set at 100 grams, 5 seconds and 25° C.

Preferred waxes include polyethylene waxes, either oxidized homopolymers of polyethylene or polypropylene, graft polymers of polyethylene or polypropylene and maleic anhydride. Preferred polyamide waxes include oleamide, N,N′-ethylenebisstearamide, bisoleorylamide, secondary amides such as erucamide, palmitamide, and stearamides, and primary amides such as stearamide, and oleamide. Preferred stearates include metallic stearates such as aluminum, calcium, magnesium, or zinc stearate. Preferred hydrocarbon waxes include petroleum or paraffinic waxes. The most preferred waxes include a polyethylene wax with maleic anhydride functionality sold under the name EPOLENE C16 by Eastman Chemicals, another polyethylene wax sold under the name of CWP 200 by Chusei (USA) Inc., polyamide waxes such as oleyl palmitamide sold under the name CRODAMIDE 203 by Croda Universal, and an ethylene bis-stearamide sold under the name CRODAMIDE EBS, also sold by Croda Universal. The waxes are generally provided at between about 1% and 4% by weight of the total components of the top layer construction.

Plasticizers useful in the invention include hydrocarbon and hydrocarbon derivatives, phthalate esters, adipates, sebacates, glutarates, epoxides, mineral oils, castor oil and vegetable oils. These may be used either singly or in combination. The plasticizer is preferably at least partially miscible with the rubber phase of the thermoplastic elastomer, and the preferred plasticizers generally have mean average molecular weights between about 330 and 8,000. Preferably, the plasticizer is present in an amount of between about 3 and 8% by weight.

The preferred plasticizers are hydrocarbon and hydrocarbon derivatives such as naphthenic, aromatic, and paraffinic hydrocarbon oils; phthalate esters such as diisonyl phthalate (DINP), di(2-ethylhexyl)dimerate, diooctyl phthalate (DOTP), polyester phthalate and tallate; polyester adipates such as diisobutyl adipate, diisodecyl adipate, diisooctyl adipate, n-octyl, and n-decyl adipate; sebacates such as polyester sebacate, dibutoxyethyl sebacate, dibutyl sebacate and dioctyl sebacate; glutarates such as long chain alkyl polyether diester, dialkyl diether glutarate and polyester glutarate; epoxides such as epoxidized octyl tallate and epoxidized glycol dioleate; trimellitates such as trioctyl trimellitate, triisooctyl trimellitate, and linear trimellitates; vegetable oils such as soybean oil; and castor oil.

Particularly preferred plasticizers include phthalate esters sold under the names PLASTHALL DINP, and PARAPLEX A-9000 by C. P. Hall, Eastman DOTP Plasticizer by Eastman Chemicals, and a tridecyl tallate sold under the name RX-13577 by C. P. Hall. A particularly preferred hydrocarbon oil is a naphthenic oil sold under the name SHELLFLEX by Shell Chemicals.

It is also useful to include a liquid rubber in the top layer of the pavement marking construction of the present invention in order to lower the modulus of the top layer. Liquid rubbers are those rubbers that are liquid at room temperature. The liquid rubbers generally will have an Mw of at least 5,000 and more often at least 20,000. Preferably, the liquid rubber has a pour point of from about −55° C. to 20° C. Such a liquid rubber functions as a semi-solid plasticizer and processing aid that does not decrease the tensile strength of the top layer of the pavement marking construction as much as conventional liquid plasticizers do. Liquid Rubbers useful in the invention include butadiene acrylonitrile copolymers, polyisoprene, polybutadiene, polybutylene, polyisobutylene, butyl rubber, polybutene, polychloroprene, polyoxypropylenes, and combinations. The preferred liquid rubbers have a mean average molecular weight between about 370 and 80,000. A particularly preferred liquid rubber is an acrylonitrile butadiene copolymer sold under the name NIPOL 1312 by Zeon Chemicals.

Adding antioxidants to the top layer is also desired as such materials improve the durability of the product. Antioxidants useful in the invention generally include hindered phenols, aromatic amines, thiesters, phosphites, and combinations. A variety of antioxidants are available from Ciba-Geigy under the general trade designations IRGANOX and IRGAFOS. For example, the hindered phenolic antioxidant n-octadecyl 3-(3,5-di-t-butyl-4hydroxyphenol)-proprionate is available under the general trade designation IRGANOX 1076. IRGANOX 1010, is identified as Tetrakis (methylene 3-Q′,W-ditert-buty]-4′-hydroxyphenol) proprionate) methane. IRGAFOS 168 is another useful antioxidant from Ciba-Geigy. Hydroquinone-based antioxidants also may be utilized, and one example of such an antioxidant is 2,5-di-tertiary-amyl-hydroquinone. Another preferred antioxidant is a hindered phenolic antioxidant sold under the name CYANOX 2110 by Cytec.

Light stabilizers, heat stabilizers, and UV absorbers also may be included in the top layer of the pavement marking constructions of the present invention. Ultraviolet absorbers include benzotriazol derivatives, hydroxy benzyi phenones, esters of benzoic acids, oxalic acid, diamides, etc. Light stabilizers include hindered amine light stabilizers, and the heat stabilizers include dithiocarbarnate compositions such as zinc dibutyl dithiocarbamate.

Retroreflective elements may be provided to improve visibility, especially nighttime visibility. The retroreflective elements used are generally glass, non-vitreous ceramic, or other durable inorganic particulate materials. Preferably such particles are between about 100 and 1500 micrometers in diameter, have a Mohs hardness of at least 6, and an index of refraction between about 1.5 and 2.0. Preferred retroreflective elements are glass beads sold under the name VISI-BEADS L-511 by Potters Industries.

The inclusion of skid-resistant particles provides improved traction to the surface of the pavement marking construction for both vehicles and pedestrians. The preferred skid-resistant particles are particles of glass, quartz, non-vitreous ceramic, carbide (silicon and boron), aluminum oxides, sandstone, pumice, calcium silicates, aluminum silicofluoride, and aluminum sesquioxide. Such skid-resistant particles may be used singly or in combination. Proper choice of skid resistant materials and percentages in the top layer should yield a top layer with at least 50 BPN (British Pendulum Number or British Portable Number) as measured by a Portable Skid Resistance Tester built by Road Research Laboratory, Crawthome, Berkshire, England. The particles should have average length dimension ranges from 0.2 to 2 mm. Generally, greater than 30% by weight of skid resistant particles are included. Preferred ceramic skid-resistant particles include products sold under the names ZIRGRIT, ZIRBLAST, and ER 120S, all sold by SEPR. Preferred glass elements include products known as WHITEBLAST, sold by Strategic Materials, Inc., and HIGHWAY SAFETY GLASS BEADS AA, sold by Potters Industries. In one embodiment, glass beads are used as the retroreflective elements with broken glass beads as the skid-resistant particles.

The fillers used in the invention include inorganics or poly-aramid, either used singly or in combination. The fillers can also include pigmented particles to impart color to the pavement marking construction. Preferred examples of fillers include talc, mica, barytes, fiberglass, glass beads, cullets (broken glass particles), calcium carbonate, titanium dioxide, silica, limestone, zinc sulfide, carbon black, metal particles and fibers. Preferred sulfates include calcium sulfates, barium sulfates, and magnesium sulfates. Preferred silicas include fumed silicas such as the product sold under the name CABOSIL TS 720 by Cabot Corporation. Preferred aramids include KEVLAR fibers, pulp, or floc. Such fillers may constitute from about 40 to 95% of the top layer of the pavement marking construction.

The adhesive layer preferably comprises a pressure sensitive adhesive construction with a balance of good surface wetting properties as well as high temperature shear performance. High cohesion strength and thus, good shear properties for the adhesive construction, can be attained by radiation curing, chemical crosslinking, fiber reinforcement, or the use of a reinforcing between two adhesive layers. A suitable pressure sensitive adhesive is disclosed in assignee's U.S. Pat. No. 4,820,746 and is available from the Specialty Tape Division of assignee as a transfer tape under the commercial name of UHA 1191. Preferably the top layer is applied to a preformed web of pressure sensitive adhesive such as by an extrusion process. Preferred coat weight for the adhesive are between about 100 and 300 grams per square meter.

In another preferred embodiment as illustrated by FIG. 2, a top layer 10 is provided as discussed above, and a reinforced adhesive layer 22 is used for added durability. The reinforced adhesive layer includes a reinforcing web 24 sandwiched between a first adhesive layer 26 and a second adhesive layer 28. The first adhesive layer adheres the reinforced adhesive layer to the top layer and the second adhesive layer adheres the entire construction to the pavement surface. One preferred reinforcing web is a nonwoven nylon reinforcing web with a weight of 0.3 ounces per square yard (11 g/m²) and sold under the name CEREX by Cerex Advanced Fabrics. Other suitable reinforcing webs include nylon, polyester, fiberglass, para aramid, polyethylene, polypropylene, polyurethane webs, or blends of such materials either in woven or nonwoven form.

While the drawing figure shows the two adhesive layers to be of roughly the same thickness, the thicknesses may be varied depending on the properties desired. In most instances, to make the construction more adherent to the generally rough pavement surfaces, the second adhesive layer should be provided as a thicker layer than the first adhesive layer. Coatweights of 75 grams per square meter for the first adhesive layer and 135 grams per square meter for the second adhesive layer have proven to be effective at adhering the pavement marking construction to a typical pavement surface.

In order to make a sheet or strip of pavement marking construction according to the present invention, a heated mixer with a nitrogen purge is set to a temperature high enough to easily mix the ingredients of the top layer. A temperature of between about 350° F. (177° C.) and 375° F. (191° C.) is generally sufficient. Any solid resin, antioxidant and a portion of the filler are added and mixed until uniform. The thermoplastic elastomer is then added and mixed until kneaded uniformly. The wax, any plasticizers, any liquid resin or rubbers, the remaining filler and any retroreflective elements or skid-resistant particles are sequentially added and mixed until uniform. The total mixing time is between one and two hours. The mixture is then formed to a film of the desired shape such as by using a press or extrusion equipment. The film can then be applied directly to a pre-formed adhesive layer and cooled, or it can be cooled first and then applied to an adhesive layer. Alternatively, an adhesive layer can be laid down on the film by known methods.

In commercially manufacturing pavement marking constructions of the present invention, either batch or continuous processes may be employed. According to a batch process, a batch mixer such as a Marion blender is heated to a processing temperature of about 375° F. (191° C.) to 400° F. (204° C.). Optionally, the mixer is blanketed with an inert gas such as nitrogen to minimize any thermal degradation during processing. The batch mixer is located about 10 to 15 ft. (3 to 5 meters) above the multiport and web so that the molten mixture can gravimetrically flow into the multiport.

The thermoplastic elastomer, solid resin, antioxidants, wax, fumed silica are added and mixed until kneaded uniformly, approximately 45 to 60 minutes. The pigment and liquid resins, if used, are added and mixed until kneaded uniformly, approximately 10 to 15 minutes. The filler and any plasticizing oil are added and mixed until kneaded uniformly, approximately 10 to 30 minutes. The glass beads or cullets are added and mixed until kneaded uniformly, approximately 20 to 30 minutes.

Once the product tube, multiport, and screener box temperatures are at about 350° F. (177° C.) to 375+F (191° C.), the valve is opened to allow the molten mixture to flow into the screener box, through the multiport, and onto a moving web of adhesive with release liner. The molten mixture layer is deposited onto the exposed adhesive layer at a thickness of about 0.060 to 0.065 inches (1.5 to 1.7 mm). When the top layer temperature is at 300+F (149° C.) to 325+F (163° C.), the retroreflective elements are applied followed by the skid-resistant particles. The construction is then run under a Viton or stainless steel roller to ensure that the retroreflective elements and skid-resistant particles are about 60% to 80% embedded in the top layer. The construction is then passed under an air blower to remove any excess retroreflective elements and skid-resistant particles. Finally, the finished construction is wound upon itself into a roll. The rolls are preferably stored at temperatures less than 80+F (27° C.) and in storage racks to minimize damage to the rolls.

For a continuous extrusion process, either a single or a twin screw counter-current extruder can be used. For a 10-zone Leistritz pilot extruder the zone temperatures are set as follows: zone 1 at 80° C., zone 2 at 120° C., zones 3 through 5 at 160° C., zone 6 at 155° C., zones 7 and 8 at 150° C., and zones 9 and 10 at 145° C. The thermoplastic elastomer and any solid resin should be set up to be fed through feeder 1, and the wax, antioxidant and fillers through feeder 2. The plasticizer and any liquid resin should be fed through liquid pump 1 and the liquid rubber and optionally the solid resin should be fed through liquid pump 2.

The feeders should be loaded and the liquid feed lines primed. The materials should be extruded at 500 rpm to form the top layer of the construction. Once the materials are extruded at the correct thickness and temperature of between about 300° F. (149° C.) and 325° F. (163° C.), the retroreflective elements are dropped onto the extrudate followed by the skid-resistant particles. The extrudate is run under a Viton or stainless steel roller to ensure that the retroreflective elements and skid-resistant particles are about 60 to 80% embedded in the extrudate to form the top layer. At the same time an adhesive layer is laminated onto the unbeaded surface of the top layer. The construction is then run through laminating rubber rolls to minimize separation between the two layers and the construction is wound upon itself. As set forth above, the rolls are preferably stored in storage racks to minimize damage, and at a temperature less than 80° F. (27° C.). As an alternative to this continuous manufacturing process in which the top layer is laid down on a pre-formed adhesive layer, the top layer and adhesive layers can be coextruded.

In order to test the durability of the constructions of the present invention, an impact tester was built similar to the vehicle wear simulator described in U.S. Pat. No. 5,453,320. The device includes two tires, each mounted on a rim. The tires used were 8-ply caster tires made by Titan and measuring 18 inches (457 mm) in diameter with a tread width of 5 11/16 inches (144 mm). The tread of the tire exhibited a Shore A Hardness of between 63 and 67. The tires were inflated to a pressure of 90 psi (6.2 bar). Each rim was mounted to an axle which in turn was mounted to a fork. The two forks were positioned at a distance from one another on a rigid horizontal frame, the forks holding the tires and rims in a vertical position parallel to one another and separated by 0.9 meters. In operation, the horizontal frame is rotated in a horizontal plane about its center point using a vertically mounted, variable-speed electric motor. The motor causes the horizontal frame to rotate such that the tires are driven in a circular path over a concrete test surface.

The concrete test surface was made of a plurality of concrete bricks arranged adjacent one another in a grid on a rigid base to form a continuous horizontal surface. Each concrete brick was 3.85 inches (98 mm) wide by 7.75 inches (197 mm) long and 2.55 inches (65 mm) thick. Individual bricks were shimmed as necessary using aluminum shims placed between the bottom of the brick and the rigid base to account for any minor variations in brick thickness, thereby providing a relatively even horizontal test surface. An outer frame held the plurality of bricks in place to prevent them from slipping with respect to the rigid base during the testing operation.

The horizontal frame also included brackets to hold a plurality of weights. During testing, weights are placed evenly about the horizontal frame's axis of rotation to provide an even downward tire force to the concrete test surface in order to simulate traffic flow across a pavement surface. The entire test apparatus was placed within an environmental chamber which permits adjustment of both temperature and humidity within the chamber to simulate different pavement conditions.

### EXAMPLE 1

A top layer for a pavement marking construction according to the present invention was prepared by blending ingredients as set forth in Table 1. All ingredients are specified in weight percent.

TABLE 1

| Ingredient | wt. % |
|---|---|
| Styrene-butadiene-styrene block copolymer (KRATON 1101) | 11.80 |
| Solid alkyd resin (UNIREZ 7021) | 8.90 |
| Liquid resin (HERCOLYN D-E) | 3.10 |
| Polyethylene wax (CWP 200) | 2.20 |
| Antioxidant (CYANOX 2110) | 0.19 |
| Fumed silica (CABOSIL TS 720) | 0.37 |
| Calcium carbonate | 32.41 |
| Retroreflective elements (HIGHWAY SAFETY GLASS | 31.38 |
| BEADS AA:WHITEBLAST (1:1)) | |
| Titanium dioxide | 9.65 |
| Total | 100.00 |

The ingredients were compounded using a one liter, heated Sigma mixer set at between 350° F. (177° C.) and 375° F. (191° C.) and including a nitrogen purge set at 8 cfm (0.2 m³/min). The alkyd resin, antioxidant, and half of the calcium carbonate were charged to the mixer and mixed to a uniform consistency. The thermoplastic elastomers were then added and mixed until uniform. The wax, plasticizers, liquid resin, rubber were added followed by the remaining calcium carbonate, titanium dioxide and retroreflective elements and the ingredients were mixed until smooth. Approximately 20 to 30 grams of the mixture was placed between two release papers in a hot press heated to between about 280° F. (138° C.) and 300° F. (149° C.). A shim 0.060 inches (1.5 mm) thick was placed around the sample and 3000 psi (201 bars) of pressure were applied to the sample for between 30 seconds and one minute until a flat film was formed. The film was then removed from the press and allowed to cool to room temperature before the release papers were removed.

### EXAMPLES 2, 3 and 4

Five sample pavement marking constructions were prepared. Sample A, B and C were the control samples while Samples D and E represented embodiments of the present invention. Samples A and B comprised STAMARK 380 and STAMARK A420 which are cold stick thermoplastic road marking constructions commercially available from 3M. Sample C comprised a strip of preformed thermoplastic hot stick pavement marking to which a pressure sensitive adhesive had been applied. The particular hot stick material was HotTape™ brand preformed thermoplastic material which is manufactured under the STIMSONITE brand by assignee. The particular adhesive used was a radiation cured rubber-based pressure sensitive adhesive of the type set forth in U.S. Pat. No. 4,820,746 and available from the Specialty Tapes Division of assignee under the name UHA 1191.

Sample D comprised a sheet of the top layer as prepared according to Example 1, and to which had been applied a layer of the same adhesive used for Sample C. Sample E comprised a sheet of the top layer as prepared according to Example 1, and to which had been applied a reinforced adhesive layer. The reinforced adhesive layer comprised a CEREX nonwoven nylon reinforcing sheet to which the same adhesive used for Samples C and D had been applied at coatweights of 75 grams per square meter for the first adhesive layer and 135 grams per square meter for the second adhesive layer as set forth above.

Sections of the pavement marking constructions of Samples A, B, C, D and E measuring 3 inches (76 mm) by 6 inches (152 mm) were individually adhered to concrete bricks and the constructions were rolled down with a heavy roller to ensure good adhesion. The concrete bricks with the pavement marking constructions applied were placed on the rigid base within the outer frame and in the path of the tires of the impact tester described above. Weights were added to the horizontal frame of the impact tester to bring the total weight on the tires to 1000 pounds. For Example 2, the environmental chamber was adjusted to −15° C. and 0% relative humidity. Once equilibrium had been reached within the chamber, the motor was started and adjusted to 40 RPM and allowed to run for 180 minutes. During the run, the individual samples were observed for failure. Failure was defined as the separation of a ¼ inch (6.4 mm) portion of the sample from the concrete brick at the leading or trailing edge of the sample, that is, the edges impacted in the tires' path. For each sample that exhibited such a failure, the time of the failure was noted. For Example 3, the test as set forth above was repeated at 23° C. and 50% relative humidity. For Example 4, the test was repeated at 40° C. and 80% relative humidity. The results of these tests are summarized in Table 2.

TABLE 2

Minutes Until Failure

| Sample | Example 2 | Example 3 | Example 4 |
|---|---|---|---|
| A (Control) | 3 | 45 | 14 |
| B (Control) | 5 | 60 | 25 |
| C (Control) | Less than 42 | No failure | 6 |
| D | No failure | About 160 | Greater than 60 |
| E | No failure | No failure | 42 |

### EXAMPLES 5 and 6

Top layers for pavement marking constructions according to the present invention were prepared by blending ingredients as set forth in Table 3 and 4. All ingredients are specified in weight percent.

TABLE 3

| Ingredient | wt. % |
|---|---|
| Styrene-butadiene-styrene block copolymer (KRATON 1101) | 10.47 |
| Ethylene vinyl acetate (ELVALOY HP 661) | 5.96 |
| Liquid resin (HERCOLYN D-E) | 3.03 |
| Solid hydrocarbon resin (EASTOTAC H100E) | 5.96 |
| Polyethylene wax (CWP 200) | 1.88 |
| Antioxidant (CYANOX 2110) | 0.19 |
| Fumed silica (CABOSIL TS 200) | 0.36 |
| Calcium carbonate | 32.04 |
| Retroreflective elements (HIGHWAY SAFETY GLASS | 30.67 |
| BEADS AA:WHITEBLAST (1:1)) | |
| Titanium dioxide | 9.43 |
| Total | 99.99 |

TABLE 4

| Ingredient | wt. % |
|---|---|
| Styrene-butadiene-styrene block copolymer (KRATON 1102) | 8.7 |
| Liquid rubber (NIPOL 1312) | 4.0 |
| Liquid resin (HERCOLYN D-E) | 3.1 |
| Solid hydrocarbon resin (EASTOTAC H100E) | 10.2 |
| Polyethylene wax (CWP 200) | 2.2 |
| Antioxidant (CYANOX 2110) | 0.2 |
| Fumed silica (CABOSIL TS 200) | 0.4 |
| Calcium carbonate | 31.0 |
| Retroreflective elements (HIGHWAY SAFETY GLASS | 30.6 |
| BEADS AA:WHITEBLAST (1:1)) | |
| Titanium dioxide | 9.6 |
| Total | 100.00 |

The ingredients were individually compounded and sample sheets of top layers were prepared as set forth in Example 1. The sample sheet using the ingredients from Table 3 was designated Example 5 and the sample sheet using the ingredients from Table 4 was designated Example 6.

### EXAMPLES 7, 8 and 9

For Examples 7, 8 and 9, tests were run at 1000 mm/min to compare the tensile strength of top layers prepared according to the present invention against commercially available cold stick pavement marking constructions. For Example 7, samples of top layers as prepared according to Examples 1, 5 and 6 were prepared as Samples F, G and H, respectively. Control Samples I, J, and K consisted of samples of commercially available cold stick pavement marking constructions from which the adhesive had been removed. The majority of the adhesive was removed from the top layers of the pavement marking constructions by scraping and the remainder was removed using a gentle solvent. Control Sample I was a sample of a material made by 3M under the trade name STAMARK 380. Control Sample J was a sample of a pavement marking construction made by Barco as a “Parking” symbol. Control Sample K was a sample of a pavement marking construction also made by Barco and intended to be used as a handicap symbol. These two products from Barco are classified as parking lots peel-and-stick rubber pavement markings and can be purchased from Barco Products Co.

For Example 7, Samples F through K were tested for tensile strength at break at 30° F. using ASTM test method D638. For Examples 8 and 9, the test was repeated using the same samples at 70° F. and at 135° F., respectively. The results are summarized in Table 5 with the tensile strength at break provided in both pounds per square inch and bars.

TABLE 5

| | Tensile Strength at Break (psi/bars) | | |
|---|---|---|---|
| Sample | Example 7 | Example 8 | Example 9 |
| F | 905 | 5392 | 93 |
| G | 1734 | 111 | 22 |
| H | 947 | 98 | 15 |
| I (Control) | 113 | 351 | 41.9 |
| J (Control) | 517 | 51.6 | 39.8 |
| K (Control) | 545 | 149 | 41.8 |

As shown by the results of examples 7, 8 and 9, the pavement marking constructions of the present invention showed generally improved strength, especially at low temperatures. These top layer formulations were chosen to exemplify the range of performance properties possible with this invention. The formulations can be adjusted or other ingredients stated herein can be incorporated to impart the desired pavement marking durability and impact resistance.

In the preferred embodiment, a pavement marking construction of the present invention is applied as follows. The pavement should be free of any freestanding water and is best applied at least 24 hours after any rainfall. The air temperature should be at least 50° F. and the pavement temperature should be at least 40° F. Preferably, both air temperature and pavement temperature are rising and the overnight air temperature is not less than 40° F. The pavement is cleaned as necessary of contaminants such as oil, grease, sand, dirt, dust, loose aggregate, curing compounds, mud, soil or salt. Preferably the pavement is cleaned using high pressure water or steam. If water or steam is used in cleaning, the pavement should be allowed to dry before the pavement marking construction is applied.

Once the pavement has been cleaned and is dry, if a release layer is provided on the pavement marking construction, it should be removed, and the construction can then be applied to the pavement. Preferably, the construction is not applied over seams, joints, or cracks in the pavement, and should not be applied over any existing markings that are deteriorated. Once applied, the construction is rolled down with a heavy roller. Preferably, the roller should be provided with a 200 pound (90 kg) load and several passes should be made over the construction to ensure that the construction's adhesive forms an intimate interface with the pavement surface. Preferably, six passes with the roller are made.

In view of the preceding description, it will be apparent to persons skilled in the art that a number of modifications can be made without departing from the invention, the scope of which is limited only by the following claims. Throughout the text and the claims, use of the word “about” in relation to a range of number is intended to modify both the low and the high values stated.

What is claimed is:

1. A pavement marking construction comprising:
a flexible layer comprising top and bottom surfaces, the top surface of the flexible layer adapted for vehicular and pedestrian traffic, the flexible layer further comprising at least one thermoplastic elastomer; at least one resin; and a wax, wherein the resin is substantially miscible with the thermoplastic elastomer upon cooling from a molten state; and
an adhesive lower layer adjacent the bottom surface of the flexible layer adapted to adhere the flexible layer to a pavement surface.

2. The pavement marking construction of claim 1 wherein the at least one thermoplastic elastomer is selected from the group consisting of natural rubber, polyisoprene, polybutadiene, polyisobutylene, butyl rubber, ethylene-propylene rubber, ethylene-propylene-diene monomer rubber, polyethylene, polybutylene, poly(alpha-olefin), styrene-butadiene random copolymers, plastomers, polyamide, styrenic block copolymers, and combinations thereof.

3. The pavement marking construction of claim 2 wherein the flexible layer comprises between about 4% and 14% by weight thermoplastic elastomer.

4. The pavement marking construction of claim 2 wherein the at least one thermoplastic elastomer is a styrenic block copolymer with at least about 30% by weight styrene.

5. The pavement marking construction of claim 1 further comprising retroreflective elements.

6. The pavement marking construction of claim 1 further comprising skid-resistant particles.

7. The pavement marking construction of claim 1 wherein the at least one resin comprises a resin selected from the group consisting of hydrocarbon resins, polyester resins, maleic resins, phenoloic resins, epoxy resins, acrylic resins, rosins, rosin derivatives, terpenes, terpene phenolic derivatives, and combinations thereof.

8. The pavement marking construction of claim 7 wherein the flexible layer comprises between about 7% and 15% by weight resin.

9. The pavement marking construction of claim 7 wherein the at least one resin is a resin system comprising at least first and second resins, wherein the first resin is a liquid resin processing aid and the second resin is a solid resin binder.

10. The pavement marking construction of claim 1 wherein the wax is selected from the group consisting of polyethylene waxes, polypropylene waxes, polyamide waxes, stearates, hydrocarbon-based waxes, and combinations thereof.

11. The pavement marking construction of claim 10 wherein the flexible layer comprises between about 1% and 4% by weight wax.

12. The pavement marking construction of claim 10 further comprising a plasticizer selected from the group consisting of phthalate esters, adipates, sebacates, glutarates, epoxides, mineral oils, vegetable oils, and combinations thereof.

13. The pavement marking construction of claim 12 wherein the flexible layer comprises between about 3% and 8% by weight plasticizer.

14. A pavement marking construction comprising:
a flexible layer comprising top and bottom surfaces, the top surface of the flexible layer adapted for vehicular and pedestrian traffic, the flexible layer further comprising between about 4% and 14% by weight thermoplastic elastomer; between about 7% and 15% by weight resin; and between about 1% and 4% by weight wax, wherein the resin is substantially miscible with the thermoplastic elastomer upon cooling from a molten state; and
an adhesive lower layer adjacent the bottom surface of the flexible layer adapted to adhere the flexible layer to a pavement surface.

15. The pavement marking construction of claim 14 wherein the thermoplastic elastomer is selected from the group consisting of natural rubber, polyisoprene, polybutadiene, polyisobutylene, butyl rubber, ethylene-propylene rubber, ethylene-propylene-diene monomer rubber, polyethylene, polybutylene, poly(alpha-olefin), styrene-butadiene random copolymers, polyamide, plastomers, styrenic block copolymers, and combinations thereof.

16 The pavement marking construction of claim 15 wherein the thermoplastic elastomer is a styrenic block copolymer with at least about 30% by weight styrene.

17. The pavement marking construction of claim 14 further comprising retroreflective elements.

18. The pavement marking construction of claim 14 further comprising skid-resistant particles.

19. The pavement marking construction of claim 14 wherein the resin is selected from the group consisting of hydrocarbon resins, polyester resins, maleic resins, phenoloic resins, epoxy resins, acrylic resins, rosins, rosin derivatives, terpenes, terpene phenolic derivatives, and combinations thereof.

20. The pavement marking construction of claim 14 wherein the wax is selected from the group consisting of polyethylene waxes, polypropylene waxes, polyamide waxes, stearates, hydrocarbon-based waxes, and combinations thereof.
